(19) United States
(12) Patent Application Publication
(10) Pub. No.: US 2014/0195619 A1
(43) Pub. Date: Jul. 10, 2014

(54) Emotive Text Messaging System

(71) Applicant: Farhang Ray Hodjat, Rancho Palos Verdes, CA (US)

(72) Inventor: Farhang Ray Hodjat, Rancho Palos Verdes, CA (US)

(21) Appl. No.: 13/735,992

(22) Filed: Jan. 7, 2013

(51) Int. Cl. H04L 12/58

(52) U.S. Cl. CPC H04L 51/08
USPC 709/206

(57) ABSTRACT

A system for expressing emotion in respective users' text messages, the system comprising: respective user text generation engines for generating emotive text messages according to respective user entered text and respective user selected emotional values associated with the text; respective user interfaces for permitting the users to enter the text and select the associated emotional value to be used in generating the emotive text message. respective displays for displaying the emotive text to respective users; wherein the emotive text is displayed as the written text against a background having a color according to the emotional value associated with the written text.

### BACKGROUND OF THE INVENTION

Text-based communications such as, for example, texting, e-mail, instant messaging, and text-based social media (e.g. Facebook™) and/or micro-blogging (e.g. Twitter™), is an increasingly popular form of human interaction. Such text-based communication generally utilizes written text that is commonly displayed as uniform throughout the text message. While useful to exchange textual information, these text-based communications are ineffective at permitting users to convey emotion associated with the textual information without “spelling it out.” For example, sarcasm often goes unnoticed by recipients because it is difficult to convey textually.

Currently users of these text-based systems associate underlying emotions through the use of “emoticons” and/or common emotion signifying acronyms. Emoticons are strings of alphanumeric characters that are used to signify emotion and/or physical gestures via text. For example, a colon followed by a close-parenthesis may indicates a smiley face, whereas a colon followed by an open-parenthesis indicates a frown, and “LMAO” may indicate the sender finds something very funny. However, especially in the case of emoticons, the possibility of recipients misinterpreting the meaning of these textual substitutes remains high.

It is therefore desirable to provide systems and methods for more accurately expressing emotion in a text message with relative ease.

### SUMMARY OF THE INVENTION

An emotive text messaging system is described herein that overcomes the limitations noted above.

The present invention facilitates creating text messages that convey emotion associated with portions of written text more accurately than without. For example, texting, e-mail and instant messaging are popular forms of text-based communication utilizing written text that is commonly displayed as uniform throughout the text message. This may be adequate for conveying information, but it is not as effective for conveying the human emotion associated with the text. The present invention differentiates portions of text messages according to user indicated emotional value. Thus, the present invention allows the user to quickly and accurately convey the emotion associated with portions of the text message. Furthermore, the present invention allows the user to express varying levels of emotion in the text message.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 illustrates a schematic illustration of an emotive text messaging system according to an embodiment of the present invention; and

FIG. 2 illustrates a schematic illustration of components of the end-user device for expressing emotion in a text message according to an embodiment of the present invention.

FIG. 3 illustrates an exemplary graphical user interface according to an embodiment of the present invention.

FIG. 4 illustrates a flowchart of a computer implemented method for expressing emotion in a text message according to an embodiment of the present invention.

### DETAILED DESCRIPTION OF THE PREFERRED EMBODIMENTS

The above described drawing figures illustrate the described invention and method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present invention.

While the present invention is described in conjunction with the preferred embodiments, it will be understood that such is not intended to be limited to these embodiments. Indeed, the present invention is intended to cover all alternatives, modifications, and equivalents thereof that may be include within the spirit and scope of the present invention as defined by the claims herein. While numerous specific details are set forth herein in order to provide a thorough understanding of the present invention, it will be understood to one having ordinary skill in the art that the present invention may be practiced without these specific details. In other instances, well-known methods, procedures, components, and circuits have not been described in detail so as not to unnecessarily obscure aspects of the present invention.

Additionally, some portions of preferred embodiments of the present invention may be described herein in terms of procedures, logic blocks, processing and or other symbolic representations of operations on data bits within a computer memory. These descriptions and representations are the means used by those skilled in the data processing arts to most effectively covey the substance of their work to others skilled in the art. According to the preferred embodiments herein, procedures, logic blocks, processes, or the like, are conceived to be self-consistent sequences of steps or instructions leading to desired results and requiring physical manipulation of physical quantities. Generally, these quantities take the form of electrical or magnetic signals capable of being stored, transferred, combined, compared, and/or otherwise manipulated in a computers system.

It will be understood by one having ordinary skill in the art that all of these and similar terms are to be associated with the appropriate physical quantities and are merely convenient labels applied to these quantities. Unless specifically stated otherwise as apparent herein, such terms refer to the actions and processes of a computers system, or similar electronic computing device, that manipulates and transforms data represented as physical (electronic) quantities within the computer system's registers and/or memories into other data similarly represented as physical quantities within the computer system's registers and/or memories and/or other such information storage, transmission or display devices.

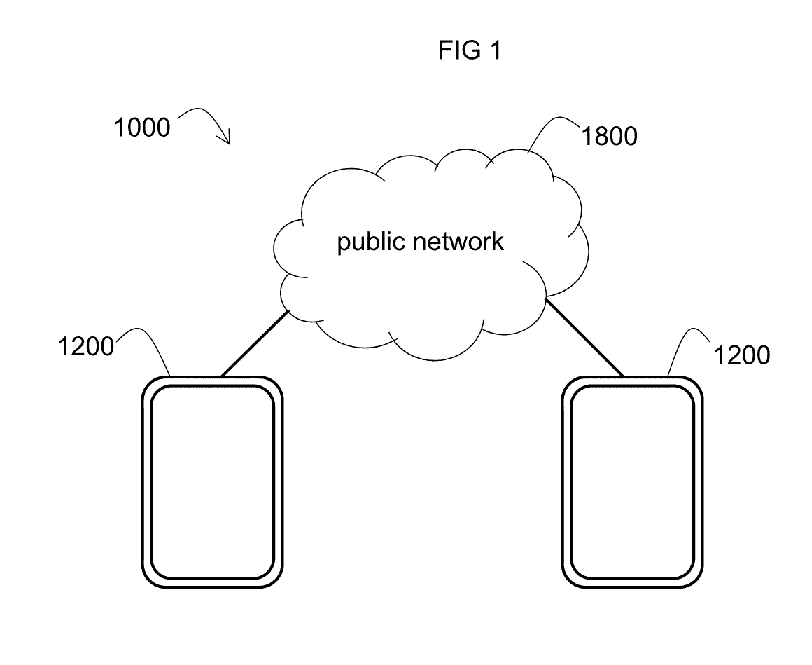

FIG. 1 shows a schematic illustration of an emotive text messaging system 1000 in accordance with a preferred embodiment, comprising one or more end-user devices 1200 communicatively coupled to a general purpose network 1800, such as the Internet, cellular or other public and/or private network. Portions of the preferred embodiment are comprised of computer-readable and computer-executable instructions stored, for example, in the end-user devices.

Each end-user device preferably includes an address/data bus for conveying digital information between the various components, a processor for processing the digital information and instructions, a random access memory (RAM) for storing the digital information and instructions, and a read only memory (ROM) for storing information and instructions of a more permanent nature. The end-user device may also comprise a data storage device (e.g. a magnetic, optical, or floppy drive, etc.) for storing data. One skilled in the art will appreciate that a software program for expressing emotion in a text message in accordance with a preferred embodiment may be stored either memory, or in an external storage device (not shown). The end-user device may additionally comprise a display device for displaying information to a user, an alphanumeric interface (e.g. an physical or touch-sensitive-display keyboard, etc.) for inputting alphanumeric data, and a cursor control interface (e.g. mouse, trackball, touch-sensitive-display, etc.) for inputting data, selections, etc. The end-user device may further comprise a network interface (e.g. a wireless transceiver, etc.) for coupling the computer system to the network. Preferably, the end-user device comprises a hand-held device, such as, for example, a Personal Data Assistant (PDA), a cellular telephone, or a tablet-type personal computing device.

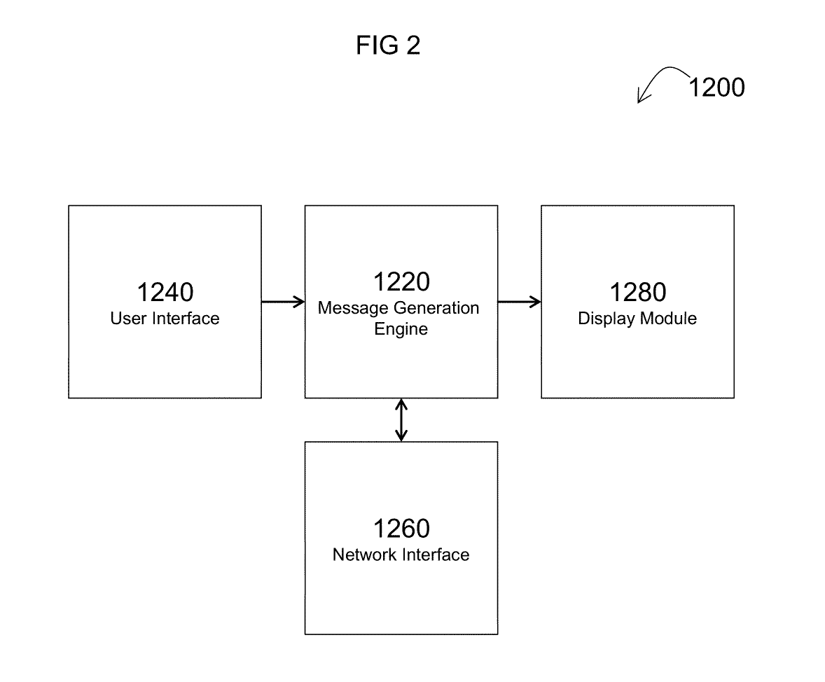

FIG. 2 shows a schematic illustration of components of the end-user device for expressing emotion in a text message in accordance with a preferred embodiment of the present invention. As shown in FIG. 2, a message engine 1220 is communicatively coupled to a user interface 1240, a network interface 1260, and a display module 1280.

In accordance with a preferred embodiment, a text message and an emotional value may be inputted by a user via the user interface. The user interface may comprise one or more of the alphanumeric interface and the cursor control interface. Preferably, the user interface comprises a graphical user interface (GUI) 1400 and a touch-sensitive display 1402 (e.g. a touch screen). The text message may comprise one or more alphanumeric characters. The emotional value may comprise one of a plurality of predefined emotional values selected by the user to be associated with the text message. The user may utilize the user interface to enter the text message, and/or to select the emotional value to associate with the text message.

In accordance with a preferred embodiment, the message engine receives the text message and the emotional value, and generates an emotive text message 1422 therefrom. The emotive text message is such that the text message may be visually identified as being associated with the emotional value. The emotive text message comprises written text information as well as emotion information indicating the written text to be visually identified as associated with the emotional value. The written text is the literal transcription of the text message. The emotion information is additional information, provided by the user, which indicates the portions of the text message associated with emotional values, and the respective emotional values thereof. Thus, the emotion information comprises data used by the display device to render the portions of the text message associated with emotional values according to the emotional values associated therewith.

In accordance with a preferred embodiment, the display module may receive the emotive text message and display it to the user via the display device. When displayed, the emotive text message may comprise the text message visually associated with an emotional value. Preferably, the emotive text message comprises the text message against a background colored according to the associated emotional value.

The emotive text message, including written text and emotion information, may also be sent via the network to a recipient end-user device, the respective text engine utilizing the written text and emotion information thereof to cause the respective display device to display the emotive text message. Accordingly, in at least one preferred embodiment, the emotive text message may be inputted via the network interface.

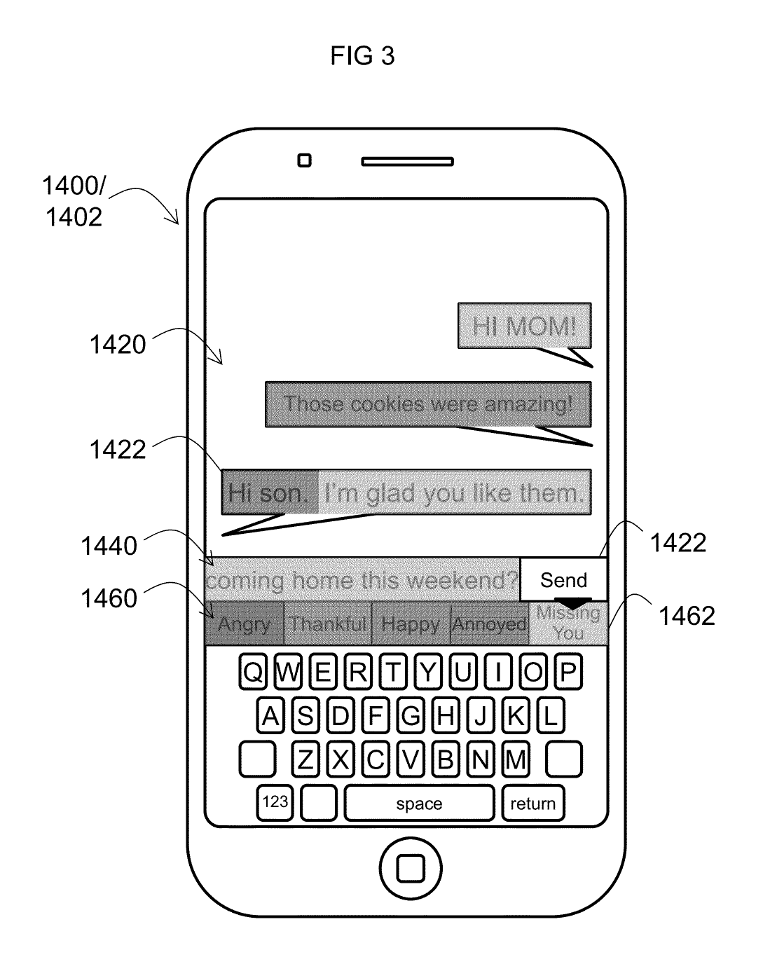

FIG. 3 shows exemplary graphical user interface according to a preferred embodiment of the present invention. The GUI may comprise a conversation area 1420 for displaying emotive text messages 1422 between the user and the recipient, a preview area 1440 for displaying the emotive text message before it is sent to the recipient comprising a send button 1442 for causing the emotive text message to be sent to the recipient, an emotion icon area 1460 comprising one or more emotion icons 1462 for selection by the user in association with the text message, and a touch-sensitive keyboard for inputting the text message.

In order to associate the emotional value with the text message, the user may select an emotion icon corresponding to the emotional value and enter the corresponding text message. Selection of the emotion icon may include utilizing the cursor control interface to select the emotion icon. Preferably, selection of the emotion icon includes selecting the emotion icon via touch-sensitive display. The user then enters the text message. While the emotion icon remains selected, the emotional value corresponding to the selected emotion icon is inputted to the message engine along with the text message.

The user may preview the emotive text message via the preview area before sending the emotive text message to the recipient by selection of the send button. This permits the user, for example, to change the associated emotional values. As discussed herein, the emotive text message is sent to the display module to be displayed as part of the GUI. In the even the user wishes to change the emotional value associated with the text message, the user may select the text message, for example, by highlighting the selected text via the cursor control interface, and select a different emotional value. The new emotive text message will then be generated and displayed according to the embodiments described herein.

When the user wishes to send the emotive text message to the recipient, the user selects the send button, for example, via the cursor control interface, and the emotive text message is sent to the recipient's end-user device via the network. As discussed herein, the recipient's respective text engine utilizes the written text and emotion information of the emotive text message to cause the recipient's respective display device to display the emotive text message in the recipient's respective conversation area. It will be understood by one of ordinary skill in the art that the recipient is a user receiving the emotive text message. Thus, through the application of the present invention, multiple users may exchange emotive text messages which may be displayed respectively.

In the example emotive text message conversation illustrated in FIG. 3, the user may want to send the following text message: “Those cookies were amazing.” In so doing, the user may wish to associate the text message with the emotion of thankfulness without needing to include the words “thank you” (or some variant thereof) in the text message. The user would select the icon associated with thankfulness and enter the text message. Alternatively, the user may select an entered text message and then select an icon. The message engine would generate the emotive text message from the text message and the selected emotional value. The emotive text message would appear in the preview area. On receiving the emotive text message, the recipient's respective text engine would interpret the emotive text message so as to display the text message against the appropriate background color for thankfulness. The recipient would therefore understand the user is expressing thanks.

It will be appreciated by one of ordinary skill in the art that the text message may be one or more sentences, clauses, words, or even alphanumeric characters. Thus, an entire communication may involve multiple text messages, each associated with a different emotional value. Returning to the example emotive text message conversation of FIG. 3, the recipient may want to send the following responsive text message: “Hi son. I'm glad you like them.” In doing so, the recipient may wish to associate the “Hi son” with the emotion of happiness and the “I'm glad you like them” with the emotion of missing you. The recipient would select the icon associated with happiness and enter the “Hi son” portion of the text message. The recipient would then select the icon associated with missing you and enter the “I'm glad you like them” portion of the text message. Alternatively, the recipient may select respective entered text messages and then select the appropriate icon accordingly. The message engine would generate the emotive text messages from respective text messages and selected emotional values. The emotive text messages would appear in the preview area. On receiving the emotive text messages, the user's text engine would interpret the emotive text messages so as to display the text messages against the appropriate background colors for happiness and missing you, respectively.

According to a preferred embodiment of the present invention, the user selected emotional value may comprise a user selected intensity level indicating the intensity of the emotion associated with the text message. Each emotional value may be associated with one or more intensity levels. For example, the emotional value of annoyed may include intensity levels ranging from slightly annoyed to very annoyed. Preferably, the intensity level is displayed as the opaqueness of the background color associated with the emotional value. For example, the background color associated with “annoyed” may be yellow, and the opaqueness (i.e. intensity) associated with “slightly” may be 15%. In this manner, the user may associate various degrees of emotion with the text message.

The intensity level may be selected by the user on selecting the emotional value. This may occur, for example, via the user utilizing the cursor interface to select the emotion icon for a period of time corresponding to the desired intensity level, i.e. cycling though available intensity levels and repeating. Furthermore, the currently selected intensity level for each emotional value may be visually apparent via the emotion icon. For example, the emotion icon may itself be colored according to the background color it is associated with and/or have opaqueness according to the current intensity level it is associated with. In this manner, the user may preview the intensity level prior to selecting it for the text message. Alternative means of selecting the intensity level may also be apparent to one of ordinary skill in the art, including utilizing drop-down menus, etc.

In addition to indicating the written text to be visually identified as associated with the emotional value, the emotion information may contain instructions that cause the recipient's device to display a hyperlink instead of the emotive text in the event that the recipient's device is does not contain the computer application whose execution causes the recipient's device to function according to the preferred embodiments described herein. On selection of the hyperlink, the recipient would be redirected to a server supported webpage where the computer application may be downloaded by the recipient. Furthermore, the emotion information may include sufficient instruction to for the recipient's device to process emotive text messages (e.g. a “lite” version).

According to a preferred embodiment, on receiving the emotive text, the user may utilize the user interface so as to cause the associated emotional value (e.g. happy, sad, etc.) to be displayed in response to user selection of the emotive text message. For example, using the touch-sensitive display, the user may touch an emotive text having a green background and thereby cause the display of the word “sad” to be associated with the emotive text message. On removal of the user's touch, the emotional value may disappear.

Additionally, the inventive systems and methods may be utilized in combination with current emotive texting means such as emoticons. In at least one preferred embodiment, emoticons may be used to input emotional values, each emoticon having an associated emotional value that may be pre-set and/or set by the user. The user may enter the text message and an emoticon, and the message engine may generate the emotive text message therefrom. This may take the form of the user entering the emoticon at any point in the text message. Preferably, however, the message engine is operable distinguish punctuation (i.e. periods, semicolons, commas) separating text messages (i.e. phrases, sentences, etc.). Emoticons entered between such punctuation may indicate separate text messages, the message engine only associating the text message where the emoticon is located with the emotional value of the emoticon. In this manner, the message engine may cause the text message to be visually identified as associated with the emotional value of the emoticon. In at least one other embodiment, identical emoticons at the beginning and end of the text message may indicate to the message engine that the enclosed text message is to be associated with the emotional value of the emoticons.

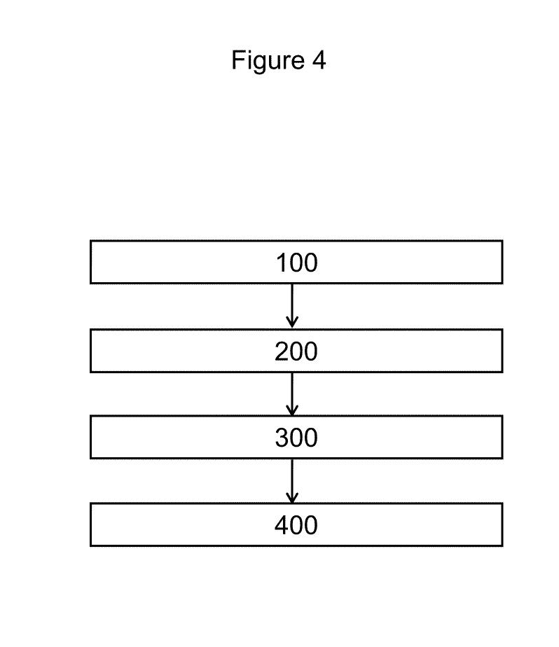

FIG. 4 is a flowchart of a computer implemented method for expressing emotion in a text message according to a preferred embodiment of the present invention.

At action block 100, a text message is associated with an emotional value. As discussed herein, a user utilizes a user interface to select an emotional value and enter a text message to be associated therewith. The emotional value is selected via selection of an emotion icon. Alternatively, as discussed herein, the user selects (e.g. by highlighting) a previously entered text message and selects the emotional value to be associated therewith. As discussed herein, the emotional value may include a user selected intensity level.

At action block 200, the message engine generates emotive text message from the text message and the emotional value. As discussed herein, the text message and the emotional value are inputted into the message generation engine and utilized thereby to generate the emotive text. The emotive text may contain written text and information associating the written text to a background color representative of the emotional value associated therewith. As discussed herein, the emotive text is thereafter displayed to the user.

At action block 300, the emotive text message is sent to the recipient. As discussed herein, the emotive text is sent to and received by the recipient via the network.

At action block 400, the emotive text is displayed to the recipient. As discussed herein, the recipient's respective message engine receives the emotive text, including the written text and the information associating the written text with a background color, and causes the emotive text to be displayed to the recipient.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A computer-readable medium having, computer-readable program code stored thereon for causing a computer system to execute a method for expressing emotion in a text message, the method comprising:
associating a portion of the text message with an emotional value;
displaying the portion of the text message on a background colored according to the associated emotional value thereof.

2. A system for expressing emotion in respective users' text messages, the system comprising:
respective user text generation engines for generating emotive text messages according to respective user entered text and respective user selected emotional values associated with the text;
respective user interfaces for permitting the users to enter the text and select the associated emotional value to be used in generating the emotive text message.
respective displays for displaying the emotive text to respective users;
wherein the emotive text is displayed as the written text against a background having a color according to the emotional value associated with the written text.
